(19) United States
(12) Patent Application Publication
(10) Pub. No.: US 2025/0148880 A1
(43) Pub. Date: May 8, 2025

(54) GAME SYSTEM

(71) Applicant: SEGA CORPORATION, Tokyo (JP)

(72) Inventors: Taro TAMUKAI, Tokyo (JP); Kenji NAGASHIMA, Tokyo (JP); Shoko KOSHIBA, Tokyo (JP); Akira YAMAUCHI, Tokyo (JP); Kento NAKAYAMA, Tokyo (JP); Shuhei NAKAYAMA, Tokyo (JP); Hayato SUGIYAMA, Tokyo (JP)

(21) Appl. No.: 19/018,735

(22) Filed: Jan. 13, 2025

Related U.S. Application Data
(63) Continuation of application No. PCT/JP2023/011112, filed on Mar. 22, 2023.

(30) Foreign Application Priority Data
Jul. 15, 2022 (JP) 2022-114301

(51) Int. Cl. G07F 17/32; A63F 9/30

(52) U.S. Cl. CPC G07F 17/3297; A63F 9/30; G07F 17/3237

(57) ABSTRACT

A management terminal receives input of a game machine ID for identifying an object acquisition game machine and a prize ID for identifying a prize to be stored in an object acquisition game machine. A server associates the prize ID with the game machine ID to update object location information indicating the location of the prize. The object acquisition game machine is a game machine with which a player attempts to acquire a prize placed in a first region by moving the prize to a second region by manipulating a crane. The management terminal receives a prize ID from a code attached to a prize by reading the code with a predetermined reader.

### CROSS REFERENCE TO RELATED APPLICATION

This application is a continuation application of International Patent Application No. PCT/JP2023/011112, filed on Mar. 22, 2023, claiming priority from Japanese Patent Application No. 2022-114301, filed on Jul. 15, 2022 in the Japan Patent Office, the contents of which being incorporated by reference herein in their entirety.

### BACKGROUND

The present disclosure relates to an object acquisition game in which an object such as a prize is acquired.

Many game arcades have crane game machines (object acquisition game machines). A crane game machine (object acquisition game machine) has a housing in which a stage (game field) is provided. Prizes (objects) such as stuffed toys and sweets are placed on the stage. A player operates an object holder such as a claw (crane) by using lateral and longitudinal direction buttons and the like. If the player can grab a prize with the claw and move the prize to a chute, the player wins the prize (refer to JP 6432143 B2).

Prizes are supplied from various manufacturers. Wholesalers buy prizes in bulk and distribute the bought prizes to a number of stores. At each store, work is done for carrying prizes distributed by wholesalers into crane game machines (object acquisition game machines).

In the carry-in work, store staff need to record which prizes have been carried and into which crane game machines (object acquisition game machines) they have been carried. If there is an error in the record during the carry-in, the locations of prizes are lost. In addition, carry-in work for replenishing prizes may be done during business hours, and carry-in work taking a long time lowers the convenience for players.

### SUMMARY

It is an aspect to provide a technology for increasing the efficiency of prize management of object acquisition game machines.

A game system according to an aspect of some embodiments includes: first and second management terminals used at a store; an object acquisition game machine installed at the store; and a server. The object acquisition game machine is a game machine with which a player attempts to acquire an object placed in a first area by moving the object to a second area by manipulating an object holder.

The first management terminal includes: an input unit configured to detect input of an object ID for identifying an object to be delivered to a store and a store ID for identifying the store to which the object is to be delivered when the object purchased by a head office managing one or more stores is to be delivered to the store; and a transmitting unit configured to transmit first data associating the object ID with the store ID to the server.

The server includes: a receiving unit configured to receive the first data; and an object managing unit configured to register, in object location information indicating a location of each object, the store as the location of the object to be delivered in accordance with the first data.

The second management terminal includes: an input unit configured to detect input of the object ID of the object to be carried into an object acquisition game machine installed in the store and a game machine ID of the object acquisition game machine into which the object is to be carried when the object delivered to the store is carried into the object acquisition game machine; and a transmitting unit configured to transmit second data associating the object ID with the game machine ID to the server.

The receiving unit of the server receives the second data, and the object managing unit of the server registers, in the object location information, the store and the as the location of the object carried into the object acquisition game machine in accordance with the second data.

Various embodiments facilitate improvement in the efficiency of prize management of object acquisition game machines.

### BRIEF DESCRIPTION OF DRAWINGS

FIG. 1 is a hardware configuration diagram of a game system;

FIG. 2 is a diagram schematically illustrating an overall configuration of a crane game machine (object acquisition game machine);

FIG. 3 is a functional block diagram of a server;

FIG. 4 is a functional block diagram of a crane game machine (object acquisition game machine);

FIG. 5 is a screen diagram of an initial screen;

FIG. 6 is a sequence diagram illustrating processes of pairing;

FIG. 7 is a data structure diagram of pairing information;

FIG. 8 is a conceptual diagram of a prize registration function;

FIG. 9 is an external view of a prize;

FIG. 10 is a functional block diagram of a management terminal;

FIG. 11 is a data structure diagram of object location information;

FIG. 12 is a screen diagram of a search screen; and

FIG. 13 is a data structure diagram of prize aggregation information.

### DETAILED DESCRIPTION

Hereinafter, a configuration and basic functions of a crane game machine (claw machine), which is one example of an object acquisition game machine, will be first described. Next, two functions of the crane game machine (object acquisition game machine) according to an embodiment, which are a “pairing function” and a “prize registration function”, will be sequentially described. Note that an “object holder” is not limited to a suspended type such as a crane (claw) but may be a hook type or a pushing type for catching or pushing a prize or the like from a side, for example. In the embodiment described below, an example of a 15 crane will be explained.

The pairing function is of a function associating a crane game machine (object acquisition game machine) with a player and is an idea similar to login, details of which will be described later. The prize registration function is a function of registering a prize to be carried into a crane game machine (object acquisition game machine) in a server.

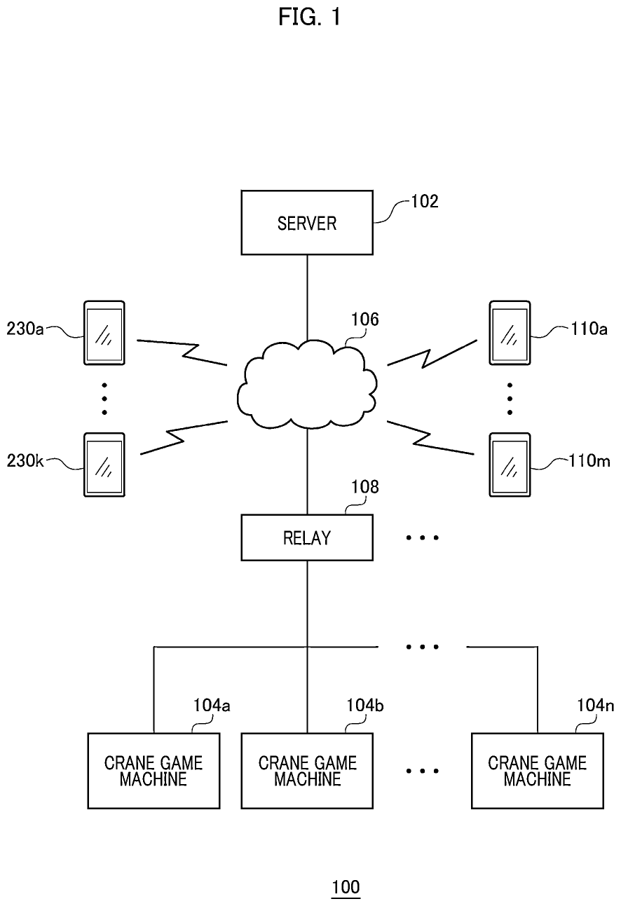

FIG. 1 is a hardware configuration diagram of a game system 100.

In the game system 100, a plurality of crane game machines (object acquisition game machines) 104a, 104b, . . . 104n (hereinafter referred to as “crane game machines (object acquisition game machines) 104” or a “crane game machine (object acquisition game machine) 104” when the crane game machines (object acquisition game machines) are collectively referred to or need not particularly be distinguished from each other), user terminals 110a, . . . , 110m (hereinafter referred to as “user terminals 110” or a “user terminal 110” when the user terminals are collectively referred to or need not particularly be distinguished from each other), and management terminals 230a, . . . , 230k (hereinafter referred to as “management terminals 230” or a “management terminal 230” when the management terminals are collectively referred to or need not particularly be distinguished from each other) are connected to a server 102 via the Internet 106.

The crane game machines (object acquisition game machines) 104 are connected with the server 102 via a relay 108. The relay 108 is a device that receives and transmits information to relay information between the server 102 and the crane game machines (object acquisition game machines) 104 and performs some functions of a server. A relay 108 is installed in every store or on each floor of each store, and is connected with one or more crane game machines (object acquisition game machines) 104. Note that the functions of a relay 108 may be integrated in the server 102 or the functions of the server 102 may be distributed to the relays 108 so that the relays 108 function as the server 102.

The user terminals 110 (communication terminals) in the embodiment are assumed to be smartphones. The user terminal 110 may be tablet terminals or laptop PCs. The user terminals 110 are wirelessly connected with the Internet 106, but may be connected in a wired manner. Each user terminal 110 has a dedicated application (hereinafter referred to as “CS (Crane Service) software”) installed therein.

The management terminals 230 are communication terminals used by people at a wholesaler (hereinafter referred to as a “head office”) in charge of bulk purchase of prizes from manufacturers, store managers or floor managers at stores, and the like. Hereinafter, people at the head office in charge of purchase, store managers, and floor managers will be collectively referred to as “managers”. The management terminals 230 are tablet terminals, but may alternatively be smart phones or laptop PCs. The management terminals 230 are also wirelessly connected with the Internet 106, but may be connected in a wired manner. Each management terminal 230 has dedicated software (hereinafter referred to as “management software”) installed therein. The crane game machines (object acquisition game machines) 104 are installed in play facilities such as amusement parks and game arcades.

A person in charge of purchase at the head office purchases prizes in bulk from manufacturers, and distributes the prizes to multiple stores, details of which will be described later. At each store, a store manager distributes the prizes to respective floor managers. Each floor manager actually carries the prize into crane game machines (object acquisition game machines) 104. For distribution and carry-in of prizes, the managers use the management terminals 230 to register information on the distribution and carry-in of prizes in the server 102.

The server 102 provides various services for a crane game, such as the pairing function and the prize registration function mentioned above. A player downloads CS software from the server 102 to a user terminal 110. Player registration is performed at this point, and the server 102 assigns a player ID to the player. The player ID is also registered in the user terminal 110. A game machine ID for identifying a crane game machine (object acquisition game machine) 104 and a store ID for identifying a store in which the crane game machine (object acquisition game machine) 104 is installed are also registered in the server 102.

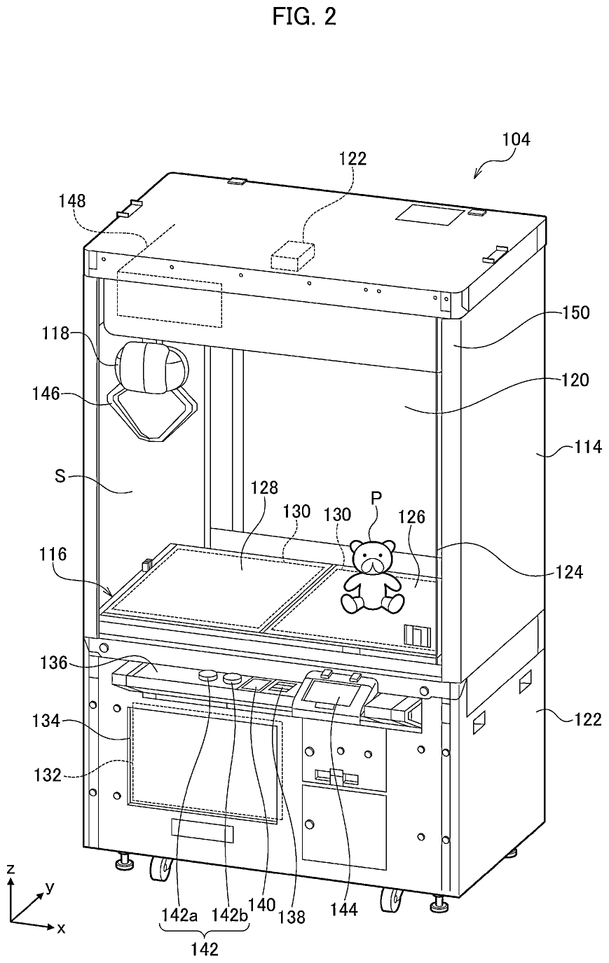

FIG. 2 is a diagram schematically illustrating an overall configuration of a crane game machine (object acquisition game machine) 104.

A crane game machine (object acquisition game machine) 104 includes a base 112 having a rectangular parallelepiped shape, and a box-like prize container 114 on the base 112. A play space S is defined in the prize container 114, in which a prize stand 116 (a game field) is located. Prizes P such as stuffed toys, goods, or the like are placed on the prize stand 116. A crane 118 is located above the prize stand 116. The crane 118 is movable in front-back, left-right and up-down directions, and can grasp and release a prize P.

The prize container 114 has a front face and left and right faces that are made of transparent glass. This is for the visibility of the prizes P from outside. A monitor 120 is installed on a back face (in the back) of the prize container 114. The monitor 120 displays various dramatic images. A camera 122 is installed on a ceiling surface of the crane game machine (object acquisition game machine) 104. The camera 122 images the prize stand 116 from above. The monitor 120 can also display images taken by the camera 122.

Light emitting diodes (LEDs) are arranged on a vertical frame 150 of the crane game machine (object acquisition game machine) 104. The LEDs are turned on as part of dramatic impact during game play. The front face of the prize container 114 has a door 124 through which an operator can put prizes P in the prize container 114. The prize stand 116 is partitioned into a first area 126 and a second area 128. Each of the areas is constituted by a removable panel. Removal of either one of the panels can form a chute 130 through which a prize P is dropped. In a case where a prize P is placed in the first area 126 and the chute 130 is formed in the second area 128, a player can acquire the prize P if the player is able to move the prize P from the first area 126 to the second area 128 (the chute 130).

A prize accommodating space 132 for accommodating a prize P dropped through the chute 130 is formed in the base 112. A front face of the base 112 has a prize slot 134 for taking out a prize P that was dropped into the prize accommodating space 132. At least one of a sensor (an infrared sensor, a weight sensor, etc.) for detecting that a prize P has dropped and a reader for detecting an IC tag or the like attached to a prize P is provided in the prize accommodating space 132. The camera 122 may image the chute 130 or the prize accommodating space 132 to determine that a prize P has dropped and the type (a prize ID) of the dropped prize. In this case, the camera 122 may be provided on a lower part of the crane 118.

A console 136 is provided on the front face side of the base 112. The console 136 includes a coin slot 138, an integrated circuit (IC) card reader 140, an operation unit 142, and a setting display 144. For starting a game, a player drops a coin into the coin slot 138 or makes an IC card charged with electronic money touch the IC card reader 140. In the latter case, payment processing of electronic money is performed, which is a known technology and detailed description of which is omitted.

The operation unit 142 includes operation buttons 142a and 142b for a player to move the crane 118. The operation unit 142 functions as a “crane operating part” configured to receive an input signal based on an operation performed by a player. The operation button 142a is a button for moving the crane 118 in the left-right directions (X direction), and the operation button 142b is a button for moving the crane 118 in the front-back directions (Y direction). In a modification, a joystick may be used to move the crane 118 in the front-back and left-right directions.

The setting display 144 includes a touch panel. The setting display 144 receives input of setting information of a game from an operator, and displays information relating the game such as how to operate the operation unit 142 and a game result. The crane game machine (object acquisition game machine) 104 also includes a speaker (not illustrated), an external connection terminal, and others.

The crane 118 has an arm 146 capable of grasping and releasing a prize P. The crane 118 includes a motor for driving the arm 146 to open and close. The arm 146 is opened and closed to release and grasp a prize P.

The crane 118 is movable along guiderails, which are not illustrated, located at an upper part of the prize container 114, and is driven by a crane drive 148. The crane drive 148 includes a moving mechanism for driving the crane 118 in the lateral directions (X direction) and the longitudinal directions (Y direction), and a lifting mechanism for driving the crane 118 in the up-down directions (Z direction). The moving mechanism includes an X-direction motor and a Y-direction motor. The lifting mechanism includes a Z-direction motor. The crane drive 148 allows the crane 118 to be moved to an intended position in the play space S. Because such drive mechanisms are known, detailed description thereof is omitted.

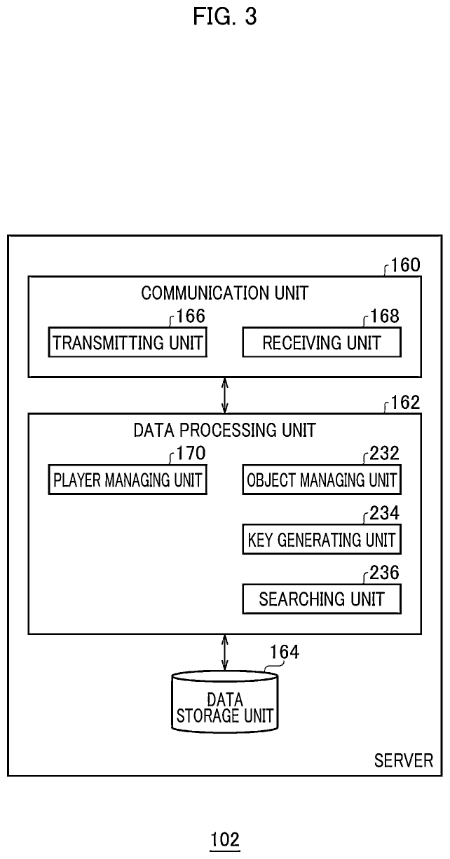

FIG. 3 is a functional block diagram of the server 102.

Respective components of the server 102 are implemented by hardware including arithmetic units such as central processing units (CPUs) and various co-processors, storage devices such as memories and storages, and wire or wireless communication lines connecting the components, and software, stored in the storage devices, for supplying processing instructions to the arithmetic units. Computer programs may be constituted by device drivers, an Operating System, various application programs on upper layers thereof, and libraries providing common functions to the programs. Blocks described below are not in units of hardware but are in units of functions.

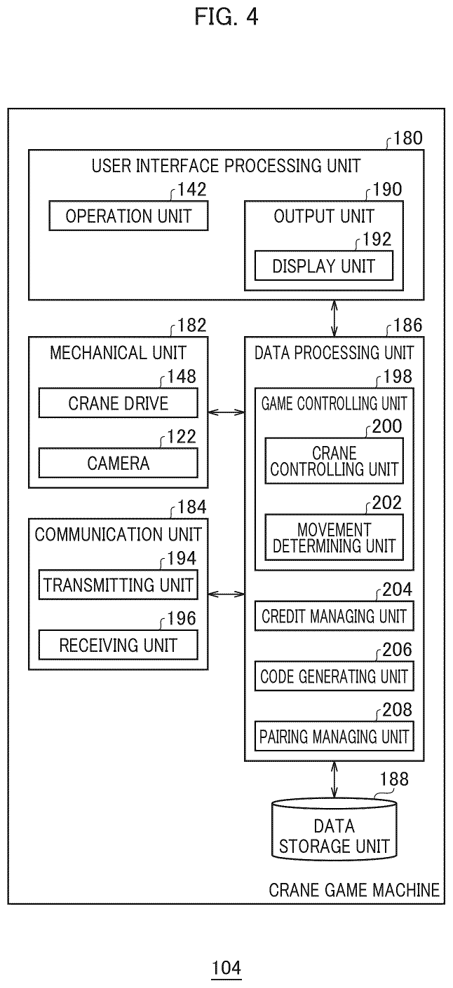

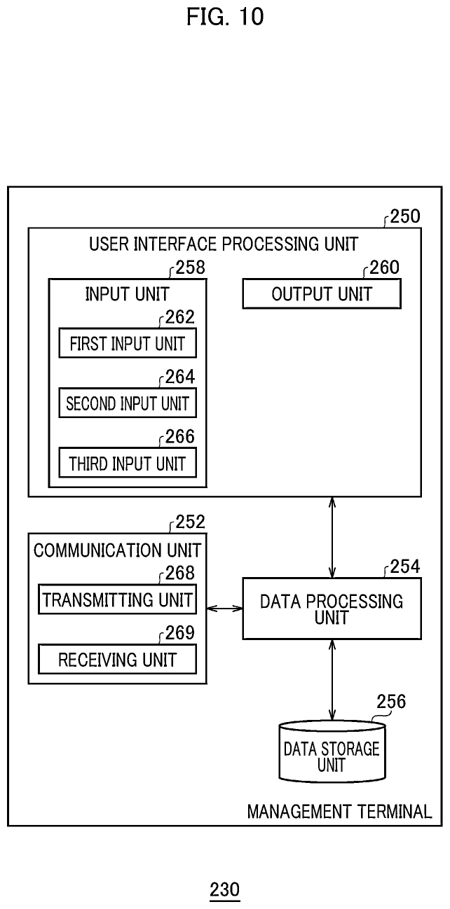

The same applies to respective components of a crane game machine (object acquisition game machine) 104 described with reference to FIG. 4 and components of a management terminal 230 described with reference to FIG. 10.

The server 102 includes a data processing unit 162, a data storage unit 164, and a communication unit 160.

The communication unit 160 performs processing for communication with the user terminals 110, the relays 108, and the management terminals 230. The data storage unit 164 stores various data. The data processing unit 162 performs various processes on the basis of data received by the communication unit 160 and data stored in the data storage unit 164. The data processing unit 162 also functions as an interface of the communication unit 160 and the data storage unit 164.

The communication unit 160 includes a transmitting unit 166 for transmitting various data, and a receiving unit 168 for receiving data.

The data processing unit 162 includes a player managing unit 170, an object managing unit 232, a key generating unit 234, and a searching unit 236. The player managing unit 170 manages information on a player for pairing and the like. The object managing unit 232 manages the locations of prizes. The key generating unit 234 generates a key code for pairing. The key code will be described later. The searching unit 236 searches for a location of a prize in accordance with a search instruction from a management terminal 230 or a user terminal 110.

FIG. 4 is a functional block diagram of a crane game machine (object acquisition game machine) 104.

The crane game machine (object acquisition game machine) 104 includes a user interface processing unit 180, a mechanical unit 182, a data processing unit 186, a communication unit 184, and a data storage unit 188.

The user interface processing unit 180 receives operations performed by a player through various input devices, and performs processing relating to a user interface image display and audio output. The mechanical unit 182 drives various mechanisms such as the crane 118 and the prize accommodating space 132. The communication unit 184 performs processing for communication with the user terminals 110 and the relay 108. The data storage unit 188 stores various data. The data processing unit 186 performs various processes on the basis of data input from the user interface processing unit 180, data received by the communication unit 184, and data stored in the data storage unit 188. The data processing unit 186 also functions as an interface of the mechanical unit 182, the user interface processing unit 180, the communication unit 184, and the data storage unit 188.

The user interface processing unit 180 includes the operation unit 142 that receives an input performed by a player, and an output unit 190 that outputs various information such as images and audio for the player. The output unit 190 includes a display unit 192 that displays images on the setting display 144 or the like. The player operates the operation unit 142 to play the crane game.

The communication unit 184 includes a transmitting unit 194 that transmits various data to the server 102 or the like, and a receiving unit 196 that receives data.

The mechanical unit 182 includes the crane drive 148 and the camera 122 (imaging unit). As described above, the camera 122 installed on the ceiling of the crane game machine (object acquisition game machine) 104 images the prize stand 116 (game field). Taken images can show the location and the course of movement of a prize. In addition, display of a taken image on the monitor 120 allows the player to more accurately see the relative positions of the crane 118 and a prize. The crane drive 148 causes the movement, grasp and release of the crane 118 as described above.

The data processing unit 186 includes a game controlling unit 198, a credit managing unit 204, a code generating unit 206, and a pairing managing unit 208.

The game controlling unit 198 controls the progress of a crane game. The game controlling unit 198 includes a crane controlling unit 200 (movement controlling unit) and a movement determining unit 202. The crane controlling unit 200 instructs the crane drive 148 to move, grasp, or release a prize in accordance with an instruction made by operation of the operation unit 142. The movement determining unit 202 determines whether or not a prize has dropped through the chute 130, or in other words, whether a crane game has resulted in a win or a loss. The credit managing unit 204 converts a play fee input in the crane game machine (object acquisition game machine) 104 by a player into credits. The code generating unit 206 generates a two-dimensional code, which will be described later. The pairing managing unit 208 manages whether or not pairing is being performed and the player ID of the player being paired. In the present embodiment, pairing is managed by both of the player managing unit 170 of the server 102 and the pairing managing unit 208 of the crane game machine (object acquisition game machine) 104.

The data storage unit 188 stores game programs of crane games, and information on a state of use such as settings and a game play result.

### [Pairing Function]

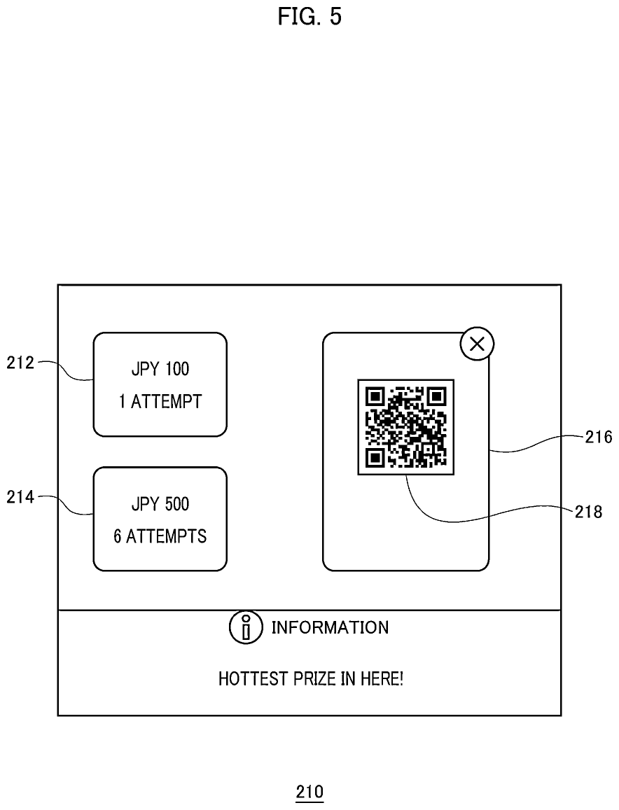

FIG. 5 is a screen diagram of an initial screen 210.

The display unit 192 causes the setting display 144 to display the initial screen 210. The setting display 144 includes a single play button 212, a multiple play button 214, and a pairing setting region 216. In the pairing setting region 216, a two-dimensional code 218 including a game machine ID and a key code is displayed. In the present embodiment, the two-dimensional code 218 will be described as a QR code (registered trademark), but may be any image from which a game machine ID and a key code can be extracted.

Before playing, the player images the two-dimensional code 218 with a camera of a user terminal 110. The CS software in the user terminal 110 extracts the game machine ID and the key code from the two-dimensional code 218, and then accesses the server 102. The server 102 thus starts pairing (to be described later). As a result of the pairing, the server 102 registers the player ID and the game machine ID in association with each other. In other words, as a result of the pairing, the crane game machine (object acquisition game machine) 104 and the player playing the crane game at the crane game machine (object acquisition game machine) 104 are associated with each other. The server 102 also notifies the crane game machine (object acquisition game machine) 104 of the player ID that is successfully paired, and the pairing managing unit 208 of the crane game machine (object acquisition game machine) 104 also registers the player ID and the game machine ID in association with each other.

After the pairing is completed, the player pays a play fee. The play fee may be paid by using coins or may be paid by using electronic money. For one attempt of the crane game, the player touches the single play button 212. After touching the single play button 212, the player pays a unit price of a credit. In the case of the crane game machine (object acquisition game machine) 104 illustrated in FIG. 5, the unit price of a credit is JPY 100. After the payment, the credit managing unit 204 generates one credit.

For six attempts of the crane game, the player touches the multiple play button 214. After touching the multiple play button 214, the player pays JPY 500 as specified. When the multiple play button 214 is touched, the credit managing unit 204 generates six credits for JPY 500 as paid. Because the player can get six credits for a play fee of five credits, it is more profitable for the player to buy six credits in bulk. Each time the crane game is played, the credit managing unit 204 subtracts one credit.

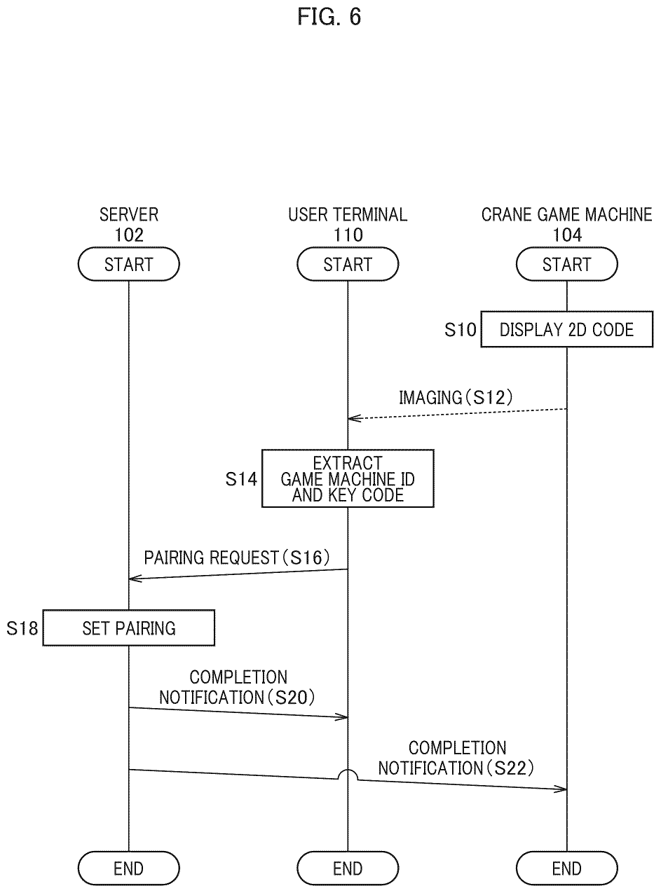

FIG. 6 is a sequence diagram illustrating processes of pairing.

First, the key generating unit 234 of the server 102 periodically generates a key code, such as at a frequency of once an hour, for example. When a new key code is generated, the transmitting unit 166 of the server 102 transmits the key code to all the crane game machines (object acquisition game machines) 104 via the relays 108. The code generating unit 206 of each crane game machine (object acquisition game machine) 104 causes a two-dimensional (2D) code 218 resulting from encoding the game machine ID and the latest key code to be displayed on the initial screen 210 (S10). A player images the two-dimensional code 218 with a user terminal 110 (S12). The CS software in the user terminal 110 extracts the game machine ID and the key code from the two-dimensional code 218 (S14), and transmits a pairing request to the server 102 (S16). The pairing request includes the game machine ID, the player ID, and the key code.

Note that the key generating unit 234 may be included in a relay 108 instead of the server 102. In this case, the relay 108 may generate a key code on the basis of unique identification information such as a serial number of the relay 108, which can prevent the key code from being the same as that for a crane game machine (object acquisition game machine) 104 connected to another relay 108. In addition, the generated key code may be transmitted from the relay 108 to the server 102 and stored in the server 102.

The receiving unit 168 of the server 102 receives the pairing request. The player managing unit 170 performs pairing setting (S18). For example, when a pairing request for pairing with a crane game machine (object acquisition game machine) 104 with a game machine ID C01 (hereinafter referred to as a “crane game machine (object acquisition game machine) 104 (C01)”) is transmitted from a player with a player ID P02 (hereinafter referred to as a “player (P02)”), the player managing unit 170 registers C01 and P02 as a “pair” in pairing information 220 (to be described later). As a result of the pairing, the server 102 can obtain the player currently playing at the crane game machine (object acquisition game machine) 104 (C01). In addition, the key code included in a pairing request matching with the latest key code issued by the server 102 or the previously issued key code is a condition for pairing. Checking of key codes will be described later.

The transmitting unit 166 of the server 102 notifies the user terminal 110 of completion of the pairing (S20). The transmitting unit 166 also notifies the crane game machine (object acquisition game machine) 104 of completion of the pairing (S22). As described above, the transmitting unit 166 notifies the crane game machine (object acquisition game machine) 104 of the paired player ID. Note that, if a pairing request is transmitted from an already paired player (user terminal 110) or if a pairing request for pairing with an already paired crane game machine (object acquisition game machine) 104 is transmitted from another player, the player managing unit 170 rejects a new pairing (which will be described later).

After the crane game is terminated, the crane game machine (object acquisition game machine) 104 transmits an unpairing request containing the game machine ID and the player ID to the server 102. At this point, the player managing unit 170 unpairs the pairing. For example, when an unpairing request is transmitted from the crane game machine (object acquisition game machine) 104 (C01) to the server 102, the player managing unit 170 unpairs the crane game machine (object acquisition game machine) 104 (C01) and the player (P02).

In another example, “provisional pairing setting” may be performed in S18, and the transmitting unit 166 of the server 102 may transmit a pairing check to the crane game machine (object acquisition game machine) 104. The display unit 192 of the crane game machine (object acquisition game machine) 104 may display a pairing check screen (not illustrated), and the transmitting unit 194 of the crane game machine (object acquisition game machine) 104 may notify the server 102 of a “pairing success” when the player has bought a credit or credits. The player managing unit 170 of the server 102 may set the pairing on the basis of receipt of this notification. The server 102 may transmit a completion notification to the user terminal 110 after the pairing is set (S20), and the CS software in the user terminal 110 may display a screen saying “You are logged in.” In this example, the process of S22 is unnecessary.

Details of the pairing will be further described. The server 102 periodically generates a key code, and transmits the key code to the crane game machines (object acquisition game machines) 104. Each crane game machine (object acquisition game machine) 104 records the latest key code received from the server 102 into an internal memory. In the present embodiment, the code generating unit 206 of each crane game machine (object acquisition game machine) 104 generates a two-dimensional code 218 containing the game machine ID and the latest key code.

Alternatively, the sever 102, instead of the crane game machines (object acquisition game machines) 104, may generate a two-dimensional code 218. For example, the server 102 may transmit a two-dimensional code 218 (image) containing the latest key code and the game machine ID to each crane game machine (object acquisition game machine) 104, and the display unit 192 of each crane game machine (object acquisition game machine) 104 may display the two-dimensional code 218 received from the server 102 in the pairing setting region 216. Alternatively, each relay 108 may generate a two-dimensional code 218 containing the latest key code received from the server 102 and a game machine ID and transmit the two-dimensional code 218 to the corresponding crane game machine (object acquisition game machine) 104. The display unit 192 of the crane game machine (object acquisition game machine) 104 may display the two-dimensional code 218 received from the relay 108 in the pairing setting region 216.

Assume that the server 102 has generated a key code Q1 at time t1, a key code Q2 at time t2, which is a predetermined time after time t1, and further a key code Q3 at time t3, which is a predetermined time after time t2. After time t3, the crane game machine (object acquisition game machine) 104 displays a two-dimensional code 218 containing the key code Q3 in the pairing setting region 216.

Assume that a player has imaged a two-dimensional code 218 and sent a pairing request to the server 102. The player managing unit 170 of the server 102 establishes the pairing if the key code contained in the pairing request is the latest key code Q3 or the previously issued key code Q2. If the key code contained in the pairing request is too old, the player managing unit 170 does not permit the pairing. The key codes are a function for preventing establishment of improper pairing, which will be described in detail below.

In view of the above, a method for preventing “double pairing”, that is, pairing two or more players with one crane game machine (object acquisition game machine) 104 will be explained.

First, assume a case where a player (P02) and a player (P03) request pairing with the crane game machine (object acquisition game machine) 104 (C01). When the pairing of the player (P02) is established first (S22), the crane game machine (object acquisition game machine) 104 does not display a two-dimensional code 218 on the initial screen 210 until the crane game machine (object acquisition game machine) 104 is unpaired. Thus, once the pairing of the player (P02) and the crane game machine (object acquisition game machine) 104 (C01) is established, the player (P03) cannot image a two-dimensional code 218 at the crane game machine (object acquisition game machine) 104 (C01). This will be referred to as a “first double pairing preventing method”.

The player (P03) may have saved a two-dimensional code 218 that was previously imaged into his/her user terminal 110. In this case, the player (P03) may transmit a pairing request based on the previously imaged two-dimensional code 218, instead of the latest two-dimensional code 218 displayed on the crane game machine (object acquisition game machine) 104 (C01), to the server 102. In this case, double pairing key code is prevented on the basis of the “issuance timing”, as described above. This will be referred to as a “second double pairing preventing method”. For example, when the player (P03) has transmitted a pairing request containing the old key code Q1, which was acquired in the past, to the server 102 after time t3, the server 102 does not permit pairing of the player (P03) because the key code Q1 is too old. This control method reduces pairing requests based on old key codes.

In the next example, assume that a player (P02) and a player (P03) have imaged the same two-dimensional code 218 displayed on the initial screen 210 at substantially the same time and transmitted pairing requests from their individual user terminals 110 to the server 102. Then, if the server 102 has received the pairing request of the player (P02) earlier than the pairing request of the player (P03), the player managing unit 170 establishes the pairing of the player (P02) with the crane game machine (object acquisition game machine) 104 (C01), and the transmitting unit 166 transmits a connection failure notification to the user terminal 110 of the later player (P03). Upon receiving the connection failure notification, the user terminal 110 (P03) displays a screen indicating the connection failure. This will be referred to as a “third double pairing preventing method”.

Next, details of unpairing will be described.

When one play of the crane game is terminated, the crane controlling unit 200 automatically returns the crane 118 to a predetermined position (home position. When no credit is newly bought for a predetermined time after the remaining number of input credits became zero and the crane 118 returned to the home position, the pairing managing unit 208 of the crane game machine (object acquisition game machine) 104 deems that the player has left the crane game machine (object acquisition game machine) 104 and unpairs the pairing. This will be referred to as “first unpairing”. First, the pairing managing unit 208 unpairs the crane game machine (object acquisition game machine) 104. In the case of the first unpairing, the crane game machine (object acquisition game machine) 104 transmits an unpairing request to the server 102. The unpairing request contains the game machine ID and the player ID. Upon receiving the unpairing request, the player managing unit 170 of the crane game machine (object acquisition game machine) 104 unpairs the pairing. In this manner, the pairing is unpaired at both of the server 102 and the crane game machine (object acquisition game machine) 104.

In such cases where some failure has occurred in the crane game machine (object acquisition game machine) 104 after a play is terminated or where a player has difficulty in getting a prize, the player may call the administrator of the machine and ask for assistance to check the status. In this case, in order to avoid the first unpairing due to a lapse of a predetermined time, an operation means such as a switch operable only by the administrator may be provided inside the crane game machine (object acquisition game machine) 104 (such as the inside thereof reachable by opening the door 124) to temporarily stop or stop the clock.

The player can also unpair a pairing by touching an unpairing button (not illustrated) displayed on the setting display 144. When the player has touched the unpairing button, the pairing managing unit 208 unpairs the pairing. This will be referred to as “second unpairing”. In this case as well, the pairing managing unit 208 first unpairs the pairing. In the second unpairing, the crane game machine (object acquisition game machine) 104 also transmits an unpairing request to the server 102. Upon receiving the unpairing request, the player managing unit 170 of the crane game machine (object acquisition game machine) 104 unpairs the pairing.

In the first unpairing and the second unpairing, performed by the crane game machine unpairing is first (object acquisition game machine) 104 and is subsequently performed by the server 102 in accordance with an unpairing request. In some cases, however, an unpairing request transmitted from the crane game machine (object acquisition game machine) 104 may not reach the server 102 owing to communication failure between the server 102 and the crane game machine (object acquisition game machine) 104 or other reasons.

When pairing is established, the crane game machine (object acquisition game machine) 104 transmits a status signal containing a player ID to the server 102 as appropriate or periodically. Thus, after the first or second unpairing is performed, the crane game machine (object acquisition game machine) 104 transmits a status signal containing no player ID to the server 102.

For example, assume that a crane game machine (object acquisition game machine) 104 (C01) and a player (P02) have been paired. Thereafter, assume that no unpairing request from the crane game machine (object acquisition game machine) 104 (C01) has reached the server 102 although the first or second unpairing was performed. In this case, an “inconsistent status” in which the crane game machine (object acquisition game machine) 104 has unpaired the pairing but the server 102 has not unpaired the pairing occurs.

In order to resolve such an inconsistent status, when a status signal containing the player ID P02 has not been received from the crane game machine (object acquisition game machine) 104 (C01) for a predetermined time, such as 10 minutes, or longer, the player managing unit 170 unpairs the pairing without an unpairing request from the crane game machine (object acquisition game machine) 104 (C01). Thereafter, the server 102 is ready to receive a new pairing request. Such unpairing autonomously performed by the server 102 will be referred to as “third unpairing”.

Note that, after unpairing, the server 102 transmits an unpairing request to the crane game machine (object acquisition game machine) 104 so that the unpairing is also performed by the crane game machine (object acquisition game machine) 104 in order to enhance the reliability. As described above, the crane game machine (object acquisition game machine) 104 transmits an unpairing request to the server 102 when unpairing is initially performed by the crane game machine (object acquisition game machine) 104, and the server 102 transmits an unpairing request to the crane game machine (object acquisition game machine) 104 when unpairing is initially performed by the server 102, which achieves error control so that no “inconsistent status” of pairing will be left.

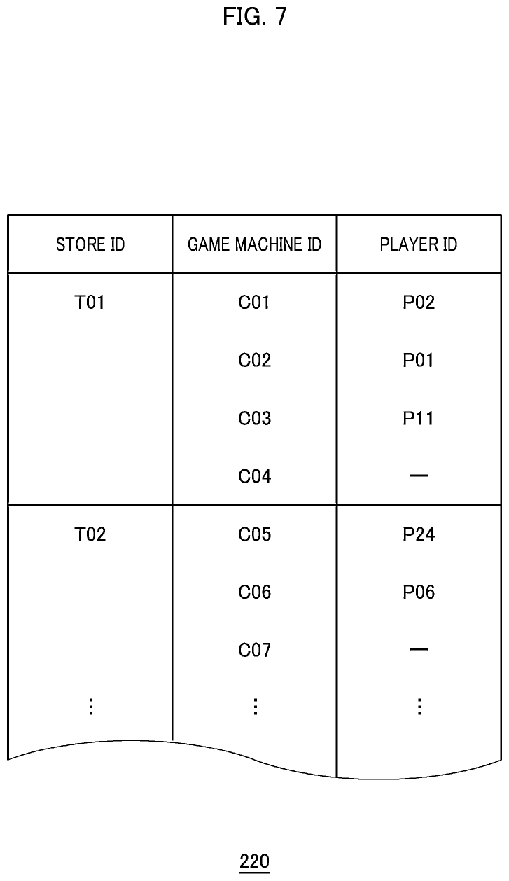

FIG. 7 is a data structure diagram of pairing information 220.

The pairing information 220 is stored in the data storage unit 164 of the server 102. Game machine IDs and store IDs are associated with each other in advance. Thus, the store in which each crane game machine (object acquisition game machine) 104 is installed is registered in the server 102.

Crane game machines (object acquisition game machines) 104 (C01) to 104 (C04) are installed in a store (T01) with a store ID T01. In addition, a crane game machine (object acquisition game machine) 104 (C05) is installed in a store (T02).

The crane game machine (object acquisition game machine) 104 (C01) is paired with a player (P02). The crane game machine (object acquisition game machine) 104 (C02) is paired with a player (P01). In addition, the crane game machine (object acquisition game machine) 104 (C04) is not paired with any player, and is therefore available to be played by any player. The player managing unit 170 registers pairing in the pairing information 220 when the pairing is established, and deletes the pairing from the pairing information 220 when an unpairing request is received.

### [Prize Registration Function]

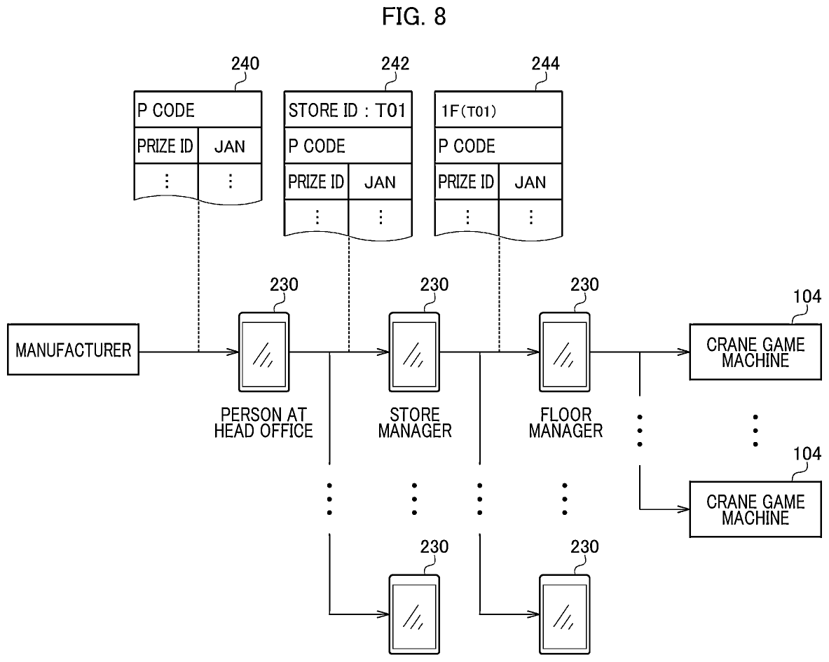

FIG. 8 is a conceptual diagram of the prize registration function.

A head office controls multiple stores. The head office purchases prizes in bulk from manufacturers. A prize ID for identifying a prize and a Japan Article Number (JAN) code representing the type of a prize are assigned to each prize. Hereinafter, the prize ID and the JAN code will be collectively referred to as a “P code” (object ID). It is possible to obtain the prize ID and the JAN code of a prize by reading the P code of the prize. A JAN code may contain a manufacturer ID for identifying the manufacturer of a prize. A prize ID is a number for identifying an individual prize, and a JAN code is a number representing the type of a prize. Hereinafter, a prize identified by a prize ID 001 and a JAN code R01 will be referred to as “prize (R01:001)”.

A person in charge of purchase at the head office orders prizes from a manufacturer by specifying the prize type by using the JAN code. The manufacturer delivers the ordered prizes to the head office, and passes first list data 240 as a prize list to the head office. The first list data 240 may be in a form of an electronic file or paper. The first list data 240 is a list of P codes of the prizes delivered to the head office. Hereinafter, the first list data 240 is assumed to be an electronic file. The person in charge of purchase at the head office makes a management terminal 230 read the first list data 240. The management terminal 230 transmits the first list data 240 to the server 102. The object managing unit 232 of the server 102 registers the delivery of the prizes to the head office in object location information 270 (to be described later).

The head office distributes the prizes purchased in bulk to individual stores. Hereinafter, the work of distributing prizes from the head office to stores will be referred to as “head office distribution work”. In the head office distribution work, the person in charge of purchase divides the first list data 240 to generate second list data 242 for each store. The second list data 242 is a list of P codes of prizes to be delivered to each store. Second list data 242 illustrated in FIG. 8 is associated with a store (T01). The head office distributes prizes to stores in accordance with the second list data 242.

At each store, a store manager makes a management terminal 230 read the second list data 242. The management terminal 230 of the store manager transmits the second list data 242 to the server 102. The object managing unit 232 registers the delivery of the prizes to the store in the object location information 270.

The store manager allocates the prizes obtained from the head office to individual floor managers. Hereinafter, the work of distributing prizes from the store manager to the floor managers will be referred to as “store distribution work”. In the store distribution work, the store manager further divides the second list data 242 to generate third list data 244 for each floor. The third list data 244 is a list of P codes of prizes to be delivered to each floor. Third list data 244 illustrated in FIG. 8 is associated with the first floor of the store (T01). The store manager distributes prizes to floors in accordance with the third list data 244.

Each floor manager carries the allocated prizes into crane game machines (object acquisition game machines) 104. Hereinafter, the work of actually carrying prizes into crane game machines (object acquisition game machines) 104 by the floor manager will be referred to simply as “carry-in work”. In the carry-in work, the floor manager inputs, into the management terminal 230, each prize being carried in and the crane game machine (object acquisition game machine) 104 into which the prize is being carried. The management terminal 230 transmits the P code of the prize being carried in and the game machine ID of the crane game machine (object acquisition game machine) 104 into which the prize is being carried. The object managing unit 232 registers the carry-in of the prize into the crane game machine (object acquisition game machine) 104 in the object location information 270.

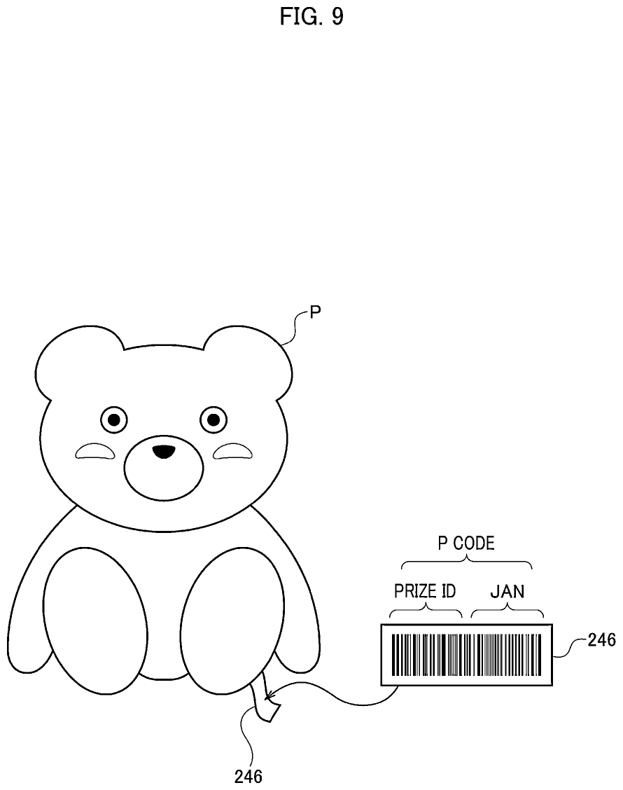

FIG. 9 is an external view of a prize.

A tag 246 is attached to a prize P. The tag 246 is a two-dimensional code such as a barcode or an IC tag such as an RFID on which the P code is recorded. During the carry-in work, a floor manager reads the P code from the tag 246 with a barcode reader, an IC reader or the like. Subsequently, the floor manager inputs, into the management terminal 230, a game machine ID of a crane game machine (object acquisition game machine) 104 into which the prize is to be carried, and the carries the prize into the crane game machine (object acquisition game machine) 104. The management terminal 230 transmits carry-in information containing the P code and the game machine ID to the server 102. The object managing unit 232 of the server 102 records the prize having been carried in and the crane game machine (object acquisition game machine) 104 into which the prize has been carried in the object location information 270 on the basis of the carry-in information.

Alternatively, in a case where a P code is optically read, the tag 246 may be read with a camera attached to the management terminal 230 instead of a barcode reader.

FIG. 10 is a functional block diagram of management terminal 230.

As described above, managers such as people in charge of purchase, store managers, and floor managers individually have their management terminals 230. In the present embodiment, the same management terminals 230 are used by the respective managers.

Each management terminal 230 includes a user interface processing unit 250, a data processing unit 254, a communication unit 252, and a data storage unit 256.

The user interface processing unit 250 receives operations performed by a player through various input devices, and performs processing relating to a user interface such as image display and audio input. The communication unit 252 performs processing for communication with the server 102 and the crane game machines (object acquisition game machines) 104. The data storage unit 256 stores various data. The data processing unit 254 performs various processes on the basis of data input from the user interface processing unit 250, data received by the communication unit 252 and data stored in the data storage unit 256. The data processing unit 254 also functions as an interface of the user interface processing unit 250, the communication unit 252, and the data storage unit 256.

The user interface processing unit 250 includes an input unit 258 that receives an input performed by a manager, and an output unit 260 that outputs various information.

The input unit 258 includes a first input unit 262, a second input unit 264, and a third input unit 266. The first input unit 262 receives input, performed by a floor manager, of the P code of a prize to be carried in and the game machine ID of a crane game machine (object acquisition game machine) 104 into which the prize is to be carried. The second input unit 264 receives input, performed by a store manager, of the P code of a prize and the store ID of a store that purchased the prize. The third input unit 266 receives input, performed by a manager, of a prize search.

The communication unit 252 includes a transmitting unit 268 that transmits various data to the server 102 or the like, and a receiving unit 269 that receives data.

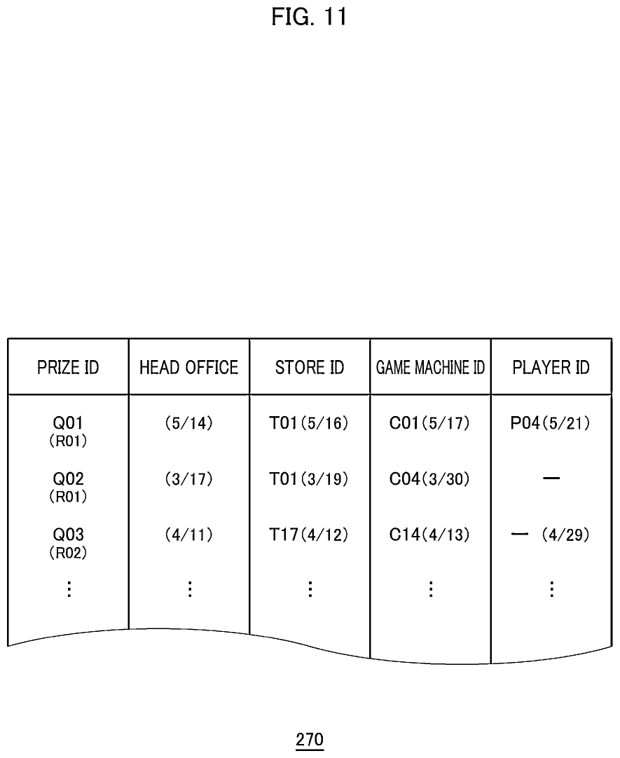

FIG. 11 is a data structure diagram of the object location information 270.

The object location information 270 is stored in the data storage unit 164 of the server 102. The object location information 270 manages the locations of prizes. According to FIG. 11, a prize (R01:Q01) was delivered to the head office on May 14 (5/14). At purchase of the prize, a person in charge of purchase at the head office reads the P code of the prize (R01:Q01) recorded in the first list data 240 and inputs the read P code into the management terminal 230. The transmitting unit 268 of the management terminal 230 transmits the read P code and the delivery date “May 14” to the server 102, and the object managing unit 232 of the server 102 registers “May 14”, which is the date on which the head office purchased the prize (R01:Q01), in the object location information 270.

The prize (R01:Q01) was delivered to a store (T01) on May 16 (5/16) through the head office distribution work. After the delivery, the store manager of the store (T01) inputs the P code of the prize (R01:Q01) in the store manager's management terminal 230. The transmitting unit 268 of the management terminal 230 transmits the P code, the delivery date “May 16” and the store ID T01 to the server 102. The object managing unit 232 records “May 16” as the date of delivery of the prize (R01:Q01) to the store (T01).

The prize (R01:Q01) was carried into a crane game machine (object acquisition game machine) 104 (C01) on May 17 (5/17) through the carry-in work. In the carry-in work, a floor manager at the store (T01) inputs the P code of the prize (R01:Q01) and the game machine ID C01 into the management terminal 230. The transmitting unit 268 of the management terminal 230 transmits the P code, the carry-in date “May 17”, and the game machine ID C01 to the server 102. The object managing unit 232 records “May 17” as the date of carrying the prize (R01:Q01) into the crane game machine (object acquisition game machine) 104 (C01).

The prize (R01:Q01) was acquired by a player (P04) on May 21 (5/21). If pairing was performed, the server 102 recognizes who played and with which crane game machine (object acquisition game machine) 104 each player played, and who acquired a prize. When the player (P04) has acquired the prize (R01:Q01), the crane game machine (object acquisition game machine) 104 (C01) transmits an acquisition notification containing the P code of the prize (R01:Q01), the player ID, and the acquisition date to the server 102. The object managing unit 232 records the acquisition of the prize (R01:Q01) by the player (P04) on “May 21” in the object location information 270.

In contrast, when a prize was acquired by a player who had not been paired, the player ID is not recorded in the object location information 270. A prize (R02:Q03) was acquired on April 29 (4/29) by a player who had not been paired. In this case, the crane game machines (object acquisition game machines) 104 (C14) transmits an acquisition notification only containing the prize (R02:Q03) and the acquisition date to the server 102.

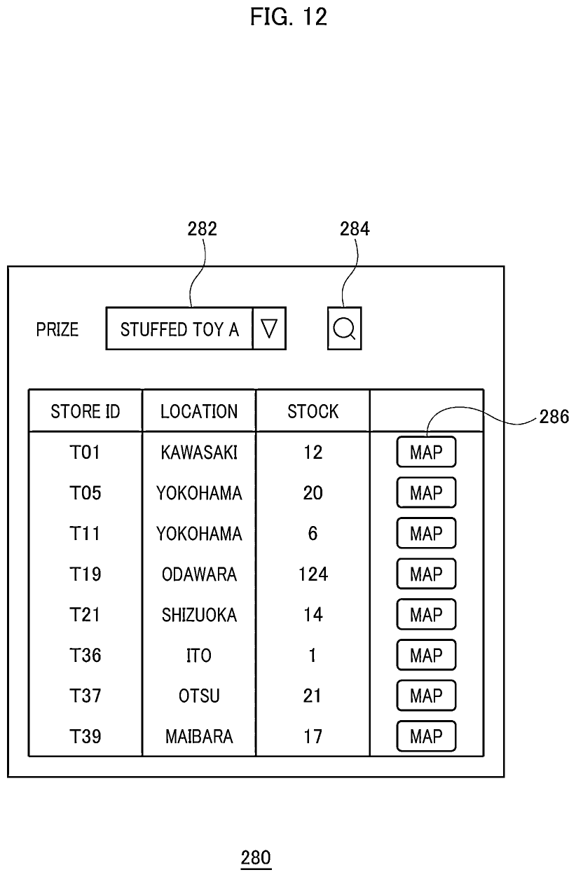

FIG. 12 is a screen diagram of a search screen 280.

The data storage unit 164 of the server 102 manages stock information (not illustrated) in which a store ID of each store is associated with the types (JAN codes) of prizes present in the store and the quantities of stock of the prizes. Each time a prize is delivered to a store, the object managing unit 232 updates the stock information. In addition, when a prize has been acquired from a crane game machine (object acquisition game machine) 104, the object managing unit 232 decrements the quantity of stock of the prize. The search screen 280 is displayed on the management terminals 230.

A manager can search for the numbers of stock of a prize at respective stores. First, the manager inputs the prize name of a prize to be searched for in a prize name region 282. The object managing unit 232 has association of each JAN code with a prize name registered in advance. After inputting the prize name in the prize name region 282, the manager touches a search button 284. The third input unit 266 of the management terminal 230 receives a search input including the prize name. The transmitting unit 268 of the management terminal 230 transmits a search request containing the prize name to the server 102. The searching unit 236 of the server 102 identifies the JAN code associated with the prize name specified by the search request, and refers to the stock information to search for the numbers of stock of the prize at respective stores. The search screen 280 is a screen showing a search result.

On the search screen 280 in FIG. 12, a prize “stuffed toy A” is a target of search. The number of stock of the prize “stuffed toy A” at a store (T01) is twelve. The server 102 has association of each store ID with store information such as a store name and a location in advance. The store (T01) is a game arcade located in Kawasaki. The manager can cause a map of an area surrounding the store (T01) to be displayed by touching a map button 286. In this manner, a manager can always know the stores where a prize is present and the numbers of stock of the prize at the stores on the search screen 280. For example, a person in charge of purchase at the head office can determine the numbers of prizes to be additionally purchased by checking the search screen 280.

The prize search can be performed not only from a management terminal 230 but also from a user terminal 110. A player inputs a prize name into a user terminal 110 on a search screen similar to the search screen 280 to transmit a search request to the server 102. The player can know to which store he/she should go in order to get a prize he/she wants by referring to the search screen.

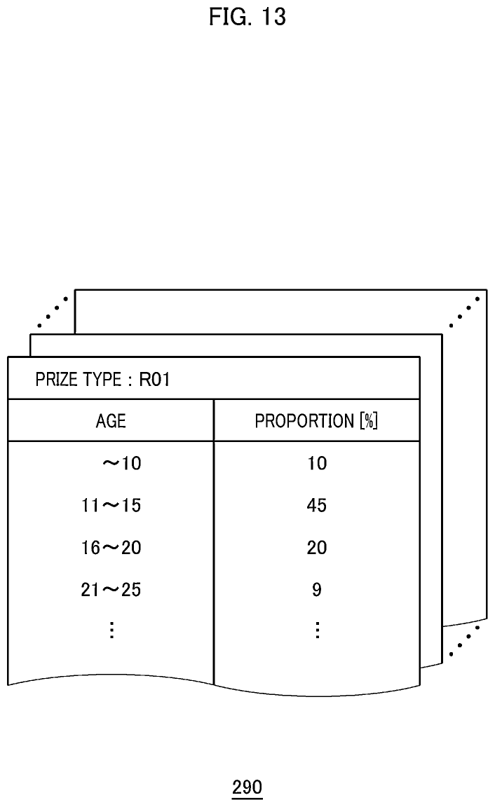

FIG. 13 is a data structure diagram of prize aggregation information 290.

For membership registration, a player registers various pieces of attribute information such as age, occupation, area of residence, and the like in the server 102. For player registration, the player managing unit 170 of the server 102 registers a player ID and the attribute information in association with each other.

The prize aggregation information 290 illustrated in FIG. 13 shows age groups of players who acquired the prize associated with a JAN code R01. When a player (P01) who is paired has acquired a prize (R01), the object managing unit 232 records the prize (R01) in association with the age group of the player (P01). Each time the prize (R01) is acquired by a player at a store, the object managing unit 232 updates the prize aggregation information 290. According to FIG. 13, 45% of players who acquired the prize (R01) are in the age group of 11 to 15 years old. This shows that the prize (R01) is popular among early teenagers.

The game system 100 according to an embodiment has been described above.

A player performs the pairing process before playing a crane game. The player can readily perform the pairing process by only imaging the two-dimensional code 218 with the user terminal 110. As a result of the pairing, the server 102 can obtain “the player who plays and the crane game machine (object acquisition game machine) 104 with which the player plays” and “the player who has acquired a prize, the prize the player has acquired, and the crane game machine (object acquisition game machine) 104 from which the player has acquired the prize”.

After purchasing prizes, a person in charge of purchase can readily know the prizes that have been purchased and the quantities of the prizes that have been purchased by referring to the first list data 240. A person in charge of purchase can specify prizes to be distributed to each store by dividing the first list data 240 to generate the second list data 242. A store manager can check the status of purchase of prizes at his/her store by referring to the second list data 242. A store manager can determine distribution of prizes to each floor by dividing the second list data 242 to generate the third list data 244. A floor manager reads the P code from the tag 246 attached to each prize, and inputs the game machine ID of the crane game machine (object acquisition game machine) 104 into which the prize is carried into the management terminal 230. As a result of such simple operations, the server 102 can manage the prizes that have been carried into crane game machines (object acquisition game machines) 104 and the crane game machines (object acquisition game machines) 104 into which each prize has been carried.

After inputting the P code and the game machine ID into the management terminal 230, the floor manager actually carries the prize into a crane game machine (object acquisition game machine) 104. The simple operation for registration of the prize in the carry-in work makes recordation error less likely to occur. Furthermore, even when the carry-in work is done during business hours, the carry-in work can be finished quickly.

Furthermore, as a result of the pairing, each crane game machine (object acquisition game machine) 104 can recognize a player ID, and the server 102 can therefore recognize when and which prize has been acquired and by which player the prize has been acquired in real time. Thus, the process in which a prize is delivered from a manufacturer to the head office, carried into a crane game machine (object acquisition game machine) 104, and acquired by a player can be tracked by the server 102. Consequently, as described with reference to FIG. 13, it is possible to analyze by what kind of players a prize has been acquired.

The present invention is not limited to the embodiment described above and modifications thereof, and any component thereof can be modified and embodied without departing from the scope of the invention. Components described in the embodiment and modifications can be combined as appropriate to form various other embodiments. Some components may be omitted from the components presented in the embodiment and modifications.

### MODIFICATIONS

In the description of the embodiment, a player performs a pairing process for pairing with a crane game machine (object acquisition game machine) 104 before playing a crane game. In a modification, a crane game may be playable without a pairing process.

The CS software in the user terminal 110 may cause a two-dimensional code obtained by encoding the player ID to be displayed on a screen of the user terminal 110. A crane game machine (object acquisition game machine) 104 images the two-dimensional code with a camera included therein. Then, the crane game machine (object acquisition game machine) 104, instead of the user terminal 110, may transmit a pairing request containing the game machine ID and the player ID to the server 102.

A player may manually input the game machine ID of a crane game machine (object acquisition game machine) 104 into the user terminal 110. Alternatively, a player may manually input the player ID into a crane game machine (object acquisition game machine) 104. In this case as well, the user terminal 110 or the crane game machine (object acquisition game machine) 104 can transmit a pairing request containing the game machine ID and the player ID to the server 102.

In the description above, a player touches an unpairing button (not illustrated) of a crane game machine (object acquisition game machine) 104 so that the second unpairing is performed. In a modification, the second unpairing may be performed when a player has touched an unpairing button (not illustrated) displayed on a user terminal 110 by the CS application of the user terminal 110. Specifically, when a player touches an unpairing button on the user terminal 110, the user terminal 110 transmits an unpairing request containing the layer ID to the server 102. The server 102 identifies a crane game machine (object acquisition game machine) 104 with which pairing of the specified player ID is established, and unpairs the pairing. The server 102 also transmits an unpairing request to this crane game machine (object acquisition game machine) 104 to also unpair the pairing at the crane game machine (object acquisition game machine) 104.

In the description of the present embodiment, each prize is associated with a P code, and each P code contains a prize ID and a JAN code. Alternatively, a prize may be associated only with a JAN code. In this case as well, the prize stock search described with reference to FIG. 12 and the prize acquisition analysis described with reference to FIG. 13 can be performed.

In the description of the present embodiment, the object managing unit 232 of the server 102 manages the locations of prizes. In a modification, relay 108 installed in a store may perform all or part of prize management.

While the object managing unit 232 obtains aggregated numbers of players who acquired each prize in respective age groups in the description above, aggregated numbers of players who attempted to acquire each prize in respective age groups may be obtained instead of players who actually acquired each prize. For example, the object managing unit 232 can obtain the age group of players who want a prize (R01) by obtaining aggregated attribute information of players of crane game machines (object acquisition game machines) 104 having the prize (R01).

Information other than age groups can also be collected. The object managing unit 232 may obtain aggregates of occupations and areas of residence of players, times when the players played, and the like for each prize. Such aggregations show the regions where a prize is popular.

The object managing unit 232 may obtain an aggregation of the number of attempts until each prize is acquired. For example, when a prize A is acquired at a tenth attempt after the prize A was carried into a crane game machine (object acquisition game machine) 104, the number of attempts for the prize A is “10”. The easiness of acquisition of a prize varies depending on the shape of the prize. As a result of calculation of the average number of attempts until acquisition of each prize, the grasping force of the arm 146 can be increased for a prize that is difficult to acquire and can be decreased for a prize that is easy to acquire so that balanced play results can be maintained.

For example, when the number of attempts for a prize X has exceeded a threshold T1, the object managing unit 232 may notify the management terminal 230 of a floor manager that adjustment for making acquisition of the prize X easier should be performed. In this case, the floor manager may adjust the settings of the crane game machine (object acquisition game machine) 104 storing the prize X to increase the grasping force of the arm 146. Such a control method makes players less likely to have an impression that the prize X is difficult to acquire. When the average number of attempts for a prize Y is smaller than a threshold T2, the object managing unit 232 may notify the management terminal 230 of the floor manager that adjustment for making acquisition of the prize Y more difficult should be performed. Because it is disadvantageous for the store if the prize Y can be acquired too easily, such a warning based on statistical results helps protect the interests of stores.

The player managing unit 170 may obtain an aggregation of the times when and the stores which a player has visited, and obtain an aggregation of the frequency of visits of each player.

Search histories of players' searches for prizes are also important information. The object managing unit 232 can find a popular prize or a prize that has attracted attention by referring to the search histories.

While a floor manager associates a prize ID with a game machine ID in the description of the present embodiment, a prize ID may be associated only with a store ID without being associated with a game machine ID. In this case as well, it is possible to search for stores where a target prize is present on the search screen 280 described with reference to FIG. 12. In addition, not only a floor manager but also a store manager and a person in charge of purchase may read the P code from the tag 246 of a prize with a barcode reader, an IC reader, or the like.

In the present embodiment, when purchasing prizes from a manufacturer, the head office receives the first list data 240 of the purchased prizes from the manufacturer. A person in charge of purchase at the head office makes a management terminal 230 read the first list data 240. The management terminal 230 transmits the first list data 240 to the server 102. The object managing unit 232 of the server 102 registers, in the object location information 270, the delivery of the prizes to the head office. In a modification, a manufacturer may have a management terminal 230. Upon delivering prizes to the head office, the manufacturer may make the management terminal 230 read the first list data 240, and make the object managing unit 232 of the server 102 register the delivery of the prizes to the head office. For example, when the first list data includes a prize (R01:Q01), a person in charge at the head office or a person in charge at the manufacturer notifies the server 102 of the “prize (R01:Q01)” from his/her management terminal 230, and the server 102 registers, in the object location information 270, that the “prize (R01:Q01)” has been delivered to the head office.

In the present embodiment, the head office distributes prizes purchased from a manufacturer to individual stores. A person in charge of purchase at the head office divides the first list data 240 to generate second list data 242 for each store. The second list data 242 is generated by a management terminal 230 of the head office. The person in charge of purchase at the head office transmits the second list data 242 to a management terminal 230 (for store) of each store from his/her management terminal 230 (for head office). At each store, the store manager makes the management terminal 230 for the store read the second list data 242 transmitted from the head office. The management terminal 230 of the store transmits the second list data 242 to the server 102. The object managing unit 232 registers, in the object location information 270, the delivery of the prizes to the store. In a modification, upon delivering prizes to each store, the head office may make its management terminal 230 read the second list data 242, and cause the object managing unit 232 of the server 102 to register the delivery of the prizes to each store. For example, when second list data for a store (T01) includes a prize (R01:Q01), a person in charge at the store or a person in charge at the head office notifies the server 102 of the “prize (R01:Q01)” and the store ID T01 from his/her management terminal 230, and the server 102 registers, in the object location information 270, that the “prize (R01:Q01)” has been delivered to the store (T01).

In the present embodiment, the store manager distributes prizes purchased from the head office to respective floors in the store. The store manager divides the second list data 242 to generate third list data 244 for each floor. The third list data 244 is generated by the management terminal 230 of the store manager. The store manager transmits the third list data 244 to a management terminal 230 of each floor manager. The floor manager makes the management terminal 230 (for floor) read the third list data 244 transmitted from the store manager. The management terminal 230 of the floor manager transmits the third list data 244 to the server 102. The object managing unit 232 may register, in the object location information 270, the delivery of the prizes to the floor. At this point, upon delivering the prizes to respective floors, the store manager may make his/her management terminal 230 read the third list data 244 to cause the object managing unit 232 of the server 102 to register the delivery of the prizes to the respective floors.

In the object location information 270 in FIG. 11, a column of “floor ID” for recording a floor in a store and the date of delivery of objects to the floor may be provided between the column of “store ID” and the column of “game machine ID”. A floor refers to a specific area in a store where one or more crane game machines (object acquisition game machines) 104 are installed. For simplicity of explanation, a floor is assumed to be a first floor in a store, and the floor ID thereof is “1F”. For example, assume that a prize (R01:Q01) is delivered to the first floor (1F) of the store (T01) on May 16 through the store distribution work. After the delivery, the floor manager of the first floor (1F) of the store (T01) inputs the P code of the prize (R01:Q01) into his/her management terminal 230. The transmitting unit 268 of the management terminal 230 for the floor transmits the P code, the delivery date “May 16”, and the floor ID 1F to the server 102. The object managing unit 232 records “May 16” as the delivery date of the prize (R01:Q01) to the first floor (1F) of the store (T01).

In the present embodiment, the floor manager carries prizes into crane game machines (object acquisition game machines) 104 by referring to the third list data 244 provided from the store manager. The floor manager inputs, to his/her management terminal 230, which crane game machine (object acquisition game machine) 104 each prize has been carried into. The management terminal 230 for the floor transmits the P code of each prize to be carried in and the game machine ID of each crane game machine (object acquisition game machine) 104 into which the prize is carried. The object managing unit 232 registers, in the object location information 270, the carrying of the prize into the crane game machine (object acquisition game machine) 104. In a modification, each crane game machine (object acquisition game machine) 104 may include an input unit. The floor manager may input, to the input unit of each crane game machine (object acquisition game machine) 104, which prize has been carried into the crane game machine (object acquisition game machine) 104. The transmitting unit 194 of the crane game machine (object acquisition game machine) 104 may transmit the P code of the prize to be carried in and the game machine ID of the crane game machine (object acquisition game machine) 104 into which the prize is carried, to cause the object managing unit 232 of the server 102 to register the carrying of the prize into the crane game machine (object acquisition game machine) 104. For example, when a prize (R01:Q01) is carried into a crane game machine (object acquisition game machine) 104 (C01), the floor manager notifies the server 102 of the “prize (R01:Q01)” and the game machine ID C01 from his/her management terminal 230 or the crane game machine (object acquisition game machine) 104 (C01). The server 102 registers, in the object location information 270, that the “prize (R01:Q01)” has been carried in the crane game machine (object acquisition game machine) 104 (C01).

As described above, a person who provides a prize may use the management terminal 230 to make the object managing unit 232 of the server 102 register that the person has provided the prize to the recipient. When the person who provides a prize performs the registration work, the person can record in the object location information 270 that the prize has left his/her management. In other words, the person can show on the object location information 270 that the prize is now managed by the recipient.

For example, assume that the recipient of the prize has not made his/her management terminal 230 read the list data and thus has not made the object managing unit 232 of the server 102 register the delivery of the prize for a certain period after receiving the prize. In this case, the object location information 270 still shows that the prize is present at the person who provided the prize, and therefore the shown location of the prize is different from the actual location thereof. If the person who provides a prize can also make the object managing unit 232 of the server 102 register the delivery of a prize, the manufacturer and the managers can obtain the location of the prize more accurately.

When the head office distributes prizes to respective stores, the management terminal 230 of the head office transmits the second list data 242 to the management terminals 230 of the stores and to the server 102. In this process, the management terminal 230 of each store manager (supplier) may put a mark indicating receipt at the store to each prize in the first list data 240 transmitted from the management terminal 230 of the head office to the server 102. The first list data 240 at the server 102 in which the mark indicating completion of distribution is put to each prize may be allowed to be checked on the management terminal 230 of the head office. Alternatively, a prize that has been delivered may be deleted from the first list data 240 at the server 102.

When a store manager distributes prizes to respective floors, the management terminal 230 of the store manager transmits the third list data 244 to the management terminals 230 of the floor managers and to the server 102. In this process, the management terminal 230 of each floor manager (recipient) may put a mark indicating receipt at the floor to each prize in the second list data 242 transmitted from the management terminal 230 of the store manager to the server 102. The second list data 242 at the server 102 in which the mark indicating completion of distribution is put to each prize may be allowed to be checked on the management terminal 230 of the store manager. Alternatively, a prize that has been carried in may be deleted from the second list data 242 at the server 102.

A floor manager carries prizes into individual crane game machines (object acquisition game machines) 104. In this process, the floor manager inputs, into the management terminal 230, each prize being carried in and the crane game machine (object acquisition game machine) 104 into which the prize is being carried. In addition, the management terminal 230 of the floor manager transmits the third list data 244, which was transmitted from the store manager, to the server 102. At this point, the management terminal 230 of the floor manager may put a mark indicating that the prize has been carried into the crane game machine (object acquisition game machine) 104 to each prize in the third list data 244 that the management terminal 230 of the floor manager transmitted to the server 102. The third list data 244 at the server 102 in which the mark indicating completion of distribution is put to each prize may be allowed to be checked on the management terminal 230 of the store manager. Alternatively, a prize that has been carried in may be deleted from the third list data 244 at the server 102.

In this manner, a mark indicating completion of a location change of a prize may be able to be put to the prize in list data each time the change work is completed. Furthermore, these list data may be shared among the managers. The location of a prize changes from a manufacturer to a head office, a store, a floor, and a crane game machine (object acquisition game machine) 104 in this order. When a mark can be put to each prize in list data, the locations of individual prizes from manufacturers through crane game machines (object acquisition game machines) 104 can be managed even though a huge number of prizes are present. In other words, the managers can manage the process of every movement of each prize from an upstream manufacturer toward a downstream crane game machine (object acquisition game machine) 104.

A mark indicating completion of a location change of a prize may be put by the recipient of the prize. Specifically, a mark is set when the recipient has confirmed receipt of the prize. For example, in a case where prizes are distributed from a store manager to respective floors, each floor manager uses the management terminal 230 to put a mark to a prize in the second list data 242. The marks put to prizes in list data allows the store managers to check information on prizes that have been received and prizes that have not been received as necessary on his/her management terminal 230. Thus, the marks put to prizes in list data allows each manager to check as necessary whether the recipient to whom he/she supplied a prize has actually received the prize.

In an example, when a prize is delivered from the head office to a store, the store manager makes his/her management terminal 230 read the second list data 242. Assume that the management terminal 230 of the store manager has registered prizes P1, P2, and P3 in the second list data 242 at this point. The management terminal 230 of the store manager transmits the second list data 242 to the server 102. Furthermore, assume that the prizes P1 and P2 have been packed in a box and delivered to a floor 1 and the prize P3 has been packed in a box and delivered to a floor 2 through the store distribution work at the same timing. For example, assume that the floor manager of the floor 1 has recognized that the packed prizes P1 and P2 have reached the floor 1 30 minutes after the delivery. The floor manager of the floor 1 opens the box to take the prizes P1 and P2 out. At this point, assume that the floor manager of the floor 1 has put marks to the prizes P1 and P2 in the second list data 242 at the server 102 by using his/her management terminal 230. In the meantime, assume that the floor manager of the floor 2 has not recognized that the packed prize P3 has reached the floor 2 even one hour after the delivery. After one hour from the delivery, the store manager checks the second list data 242 at the server 102 by using his/her management terminal 230. At this point, because the marks are put to the prizes P1 and P2, the store manager can recognize that the prizes P1 and P2 are certainly delivered to the floor 1. In contrast, because no mark is put to the prize P3, the store manager recognizes that the prize P3 has not been delivered to the floor 2. As a result of this check result, the store manager can quickly instruct the floor manager of the floor 2 to check the delivery of the prize P3.

1. A game system comprising:
first and second management terminals used at a store; an object acquisition game machine installed at the store; and a server,
wherein the object acquisition game machine is a game machine with which a player attempts to acquire an object placed in a first area by moving the object to a second area by manipulating an object holder,
wherein the first management terminal includes:
an input unit configured to detect input of an object ID for identifying an object to be delivered to a store and a store ID for identifying the store to which the object is to be delivered when the object purchased by a head office managing one or more stores is to be delivered to the store; and
a transmitting unit configured to transmit first data associating the object ID with the store ID to the server,
wherein the server includes:
a receiving unit configured to receive the first data; and
an object managing unit configured to register, in object location information indicating a location of each object, the store as the location of the object to be delivered in accordance with the first data,
the second management terminal includes:
an input unit configured to detect input of the object ID of the object to be carried into an object acquisition game machine installed in the store and a game machine ID of the object acquisition game machine into which the object is to be carried when the object delivered to the store is carried into the object acquisition game machine; and
a transmitting unit configured to transmit second data associating the object ID with the game machine ID to the server,
wherein the receiving unit of the server receives the second data, and
the object managing unit of the server registers, in the object location information, the store and the as the location of the object carried into the object acquisition game machine in accordance with the second data.

2. The game system according to claim 1,
wherein the object acquisition game machine includes a transmitting unit configured to transmit the object ID and a player ID for identifying a player when the player has acquired the object, and
wherein when the player has acquired the object from the object acquisition game machine, the object managing unit of the server updates the object location information by registering the player ID of the player and the object ID of the acquired object in association with each other.

3. The game system according to claim 1, further comprising:
a third management terminal used at the head office,
wherein when a plurality of objects are purchased by the head office, the third management terminal transmits, to the server, delivery of the plurality of purchased objects, and
wherein the object managing unit of the server registers the plurality of purchased objects as purchase completed.

4. The game system according to claim 1,
the input unit of the second management terminal reads a code attached to an object with a predetermined reader to receive an object ID from the code.

5. The game system according to claim 2,
wherein provided that pairing of the object acquisition game machine and the player is registered,
when the player has acquired the object, the object managing unit registers the player ID and the object ID of the acquired object in association with each other.

6. The game system according to claim 5,
wherein the server further includes a player managing unit configured to register pairing for associating a player and an object acquisition game machine, and
wherein upon receiving a pairing request containing a player ID and a game machine ID, the player managing unit registers pairing of the player ID and the game machine ID.

7. The game system according to claim 2,
wherein the server further comprises a data storage unit configured to manage stock information indicating the number of stock of objects in each store, and
wherein each time an object is delivered to a store, the object managing unit updates the stock information of the data storage unit, and each time an object is acquired by a player, the object managing unit updates the stock information in the data storage unit.

8. The game system according to claim 2,
wherein the server further includes a searching unit configured to refer to the stock information to detect the number of stock of objects of a specified type in each store when the type of objects is specified by a search instruction.
